(19) United States
(12) Patent Application Publication
(10) Pub. No.: US 2005/0021374 A1
(43) Pub. Date: Jan. 27, 2005

(54) System and method for providing automated accident management services

(76) Inventor: Komron Michael Allahyari, Mercer Island, WA (US)

Correspondence Address: CHRISTENSEN, O'CONNOR, JOHNSON, KINDNESS, PLLC, 1420 FIFTH AVENUE, SUITE 2800, SEATTLE, WA, 98101-2347, US

(21) Appl. No.: 10/897,208

(22) Filed: Jul. 22, 2004

Related U.S. Application Data
(60) Provisional application No. 60/490,389, filed on Jul. 25, 2003.

(51) Int. Cl. G06F 17/60; G06G 7/00; G06F 17/00; G08B 23/00

(52) U.S. Cl. 705/2; 705/400; 705/4

(57) ABSTRACT

An accident management service is presented. The service collects accident-related information for an accident person. Based on the collected information, the service generates a settlement value and supporting settlement forms and/or letters. In one embodiment, the service generates the settlement value by determining a settlement rating. Medical costs in the accident-related information are then multiplied by the settlement rating and non-medical damages are added to the product of the multiplication to generate the settlement value. In an alternative embodiment, a baseline value is determined for the accident person's medical conditions identified in the accident-related information. For each day of the medical conditions, the baseline value is added to a current total. Additionally, the current total is adjusted according to whether the pain for that day is above or below an average pain level.

### CROSS-REFERENCE TO RELATED APPLICATION(S)

This application claims the benefit of U.S. Provisional Patent Application No. 60,490,389, filed Jul. 25, 2003, which is incorporated herein by reference.

### FIELD OF THE INVENTION

The present invention relates to a computer implemented system and method for providing accident management services to a user.

### BACKGROUND OF THE INVENTION

According to current estimates, there are over 185 million drivers on the road in the U.S. With so many drivers on the road, it is no surprise that there are almost 20 million car accidents each year. Correspondingly, automobile accident claims are the most common type of civil litigation pending in the judicial system today. They are also the leading subject matter of insurance claims.

For purposes of simplicity in description, a person involved in an accident, whether as a driver, passenger, or owner of a vehicle or property involved in an accident, will be referred to as an accident person.

When an accident unfortunately occurs, an accident person can be overwhelmed by a myriad of very difficult issues that may arise after the accident's timeframe. In other words, after the police have been summoned and the accident scene investigated, after possible citations are issued, after insurance information has been exchanged, after witnesses have been identified, and after the accident has been cleared away, other equally difficult issues arise. The accident person may need to arrange alternative transportation, file insurance claims, seek medical treatment, and arrange for time off at work while receiving medical treatment. These and other issues all seem to converge on an accident person in an overwhelming manner. This is especially true as the severity of the accident increases. It is often very difficult for that accident person to manage, even cope with, all of the consequent issues. Thus, people often turn to others for assistance, including their insurance carrier (for payment of medical bills and other expenses) and/or an attorney (for recovery of all damages against an at-fault party or his insurance carrier).

Unfortunately, when an accident person (an insured accident person) turns to his/her insurance carrier, the accident person frequently realizes that the insurance carrier is not necessarily on the insured's side. In other words, while the perception is that one's insurance carrier is there to help, there may be very real conflicts between the accident person and the insurance carrier. Primarily, these conflicts have a common root in the fact that the insurance carrier may want to minimize payment of costs associated with an accident. Preferably (to the insurance carrier), others should bear the costs associated with an accident. Thus, insurance claims are denied, accident costs and property values are disputed, liability is disputed, and the like. To the accident person, the accident person's insurance carrier may seem like just another opposing party.

As insurance companies are often adversarial to the insured accident person (or at least perceived as adversarial to the accident person), an accident person will often turn to an attorney for assistance to recover damages caused by an at-fault party. However, it is not always easy for the accident person to engage an attorney to recover accident-related damages. Most attorneys work on a contingent fee basis, meaning the attorney will get paid only if there is a recovery. For various reasons, given a certain set of circumstances, a particular accident person's case may not present a strong likelihood of recovery. For the attorney that takes such a case on, there is a real risk of not being paid, even for out-of-pocket expenses. Thus, attorneys generally evaluate each accident case to determine whether it is worth the effort and risk to represent the accident person. Especially in smaller cases where the return on investment is lower, finding a willing attorney can be a difficult, frustrating, and, at times, an impossible task for the accident person.

In light of the above-described issues, what is needed is a system and method for providing accident management services to assist an accident person in organizing and gathering accident-related information, make reasoned assessments of accident damages, estimate the amount of recovery, and generate organized accident-related letters and reports. The present invention addresses these and other issues found in the prior art.

### SUMMARY OF THE INVENTION

According to aspects of the present invention, a computer-implemented method for generating settlement information for an accident person in regard to an accident is presented. Accident-related information for the accident person is collected. A settlement function by which a settlement value may be derived from the collected accident-related information is determined. The settlement function is then applied to the accident-related information, thereby generating the settlement value for the accident person.

According to additional aspects of the present invention, a computer-implemented method for generating settlement information for an accident person in regard to an accident is presented. Accident-related information for the accident person is collected. A baseline value for accident-related medical conditions identified in the accident-related information is obtained. For each day the accident person experiences the medical conditions, the baseline value is added to a current total and an adjustment is made to the current total corresponding to whether the pain level of the medical conditions for that day was higher or lower than an average pain level. Non-medical damages are added to the current total, thereby generating the settlement value.

According to additional aspects of the present invention, a computer-readable medium bearing computer-executable instructions which, when executed on a computing device, carry out a method for generating settlement information for an accident person in regard to an accident is presented. Accident-related information for the accident person is collected. A settlement rating is determined, derived from the collected accident-related information, by determining a plurality of accident-related ratings according to aspects of the accident-related information, and averaging the plurality of accident-related ratings, thereby determining the settlement rating. The medical costs are multiplied by the settlement rating, and non-medical damages are added to the product of the multiplication.

According to still further aspects of the present invention, a computer-readable medium bearing computer-executable instructions which, when executed on a computing device, carry out a method for generating settlement information for an accident person in regard to an accident is presented. Accident-related information for the accident person is collected. A baseline value for accident-related medical conditions identified in the accident-related information is obtained. For each day of the medical conditions, the baseline value is added to a current total, and the current total is adjusted according to whether the pain level of the medical conditions for that day was higher or lower than an average pain level. Non-medical damages are added to the product of the multiplication, thereby generating a settlement value.

According to still further aspects of the present invention, a network-based system for generating settlement information for an accident person in regard to an accident is presented. The system includes an accident person computer. The accident person computer submits accident-related information to an accident management service for generating settlement information and receiving the settlement information from the accident management service. The system also includes an accident management service. The accident management service is coupled to the accident person computer via a network connection. The accident management service collects accident-related information for the accident person from the accident person computer, wherein the accident-related information comprises medical and non-medical damages. The accident management service further determines a settlement rating, derived from the collected accident-related information. The settlement rating is determined by generating a plurality of accident-related ratings according to aspects of the accident-related information, and averaging the plurality of accident-related ratings, thereby generating the settlement rating. The accident management service multiplies the medical costs by the settlement rating and adds non-medical damages to the product of the multiplication, thereby generating a settlement value. The accident management service returns the settlement value to the accident person computer.

In accordance with yet further aspects of the present invention, a network-based system for generating settlement information for an accident person in regard to an accident is presented. The system includes an accident person computer. The accident person computer submits accident-related information to an accident management service for generating settlement information and receiving the settlement information from the accident management service. The system also includes an accident management service. The accident management service collects accident-related information for the accident person from the accident person computer, wherein the accident-related information comprises medical and non-medical damages. The accident management service obtains a baseline value for accident-related medical conditions identified in the accident-related information. For each day of the medical conditions identified in the accident-related information, the accident management service adds the baseline value to a current total, and adjusts the current total according to whether the pain level associated with the medical conditions for that day was higher or lower than an average pain level. The accident management service adds non-medical damages to the current total thereby generating a settlement value.

### BRIEF DESCRIPTION OF THE DRAWINGS

The foregoing aspects and many of the attendant advantages of this invention will become more readily appreciated as the same become better understood by reference to the following detailed description, when taken in conjunction with the accompanying drawings, wherein:

FIG. 1A is a block diagram illustrating an exemplary environment suitable for implementing aspects of the present invention;

FIG. 1B is a block diagram illustrating an alternative exemplary environment suitable for implementing aspects of the present invention;

FIG. 2 is a flow diagram illustrating an exemplary routine for providing accident management services to a user;

FIG. 3 is a flow diagram illustrating an exemplary subroutine, suitable for use in the exemplary routine of FIG. 2, for collecting accident-related information;

FIG. 4 is a flow diagram illustrating an exemplary subroutine, suitable for use in the exemplary routine of FIG. 2, for generating accident values according to aspects of the present invention;

FIG. 5 is a flow diagram illustrating an exemplary subroutine, suitable for use in the exemplary subroutine of FIG. 4, for determining a settlement value for accident-related damages;

FIG. 6 is a flow diagram illustrating an alternative exemplary subroutine, suitable for use in the exemplary subroutine of FIG. 4, for determining a settlement value for accident-related damages;

FIG. 7 is a flow diagram illustrating an exemplary routine for providing accident management services to an accident person and in assisting an attorney in evaluating the accident case presented by the accident person for representation; and

FIG. 8 is a flow diagram illustrating an exemplary subroutine, suitable for use in the exemplary routine of FIG. 7, for determining an accident case rating and completion percentage for evaluating the case for possible representation.

### DETAILED DESCRIPTION

As indicated above, a system and method for providing automated accident management services is presented. Many advantages are realized through this system and method. For example, the system presents the accident person with a means for collecting, organizing, and managing information related to an accident. This in turn enables the accident person to present the accident person's claims in a reasonable and organized manner to other parties, such that it encourages other parties, including insurance carriers, to settle claims. Additionally, even when the other party is disinclined to settle a dispute, the information generated by the present invention can be advantageously utilized either during formal dispute resolution or in civil litigation. As also indicated above, this organized information lends itself to assisting attorneys evaluate the “case” for potential representation. Quite often, the organized nature of the accident-related facts also lend themselves to creating a more desirable “case” for an attorney.

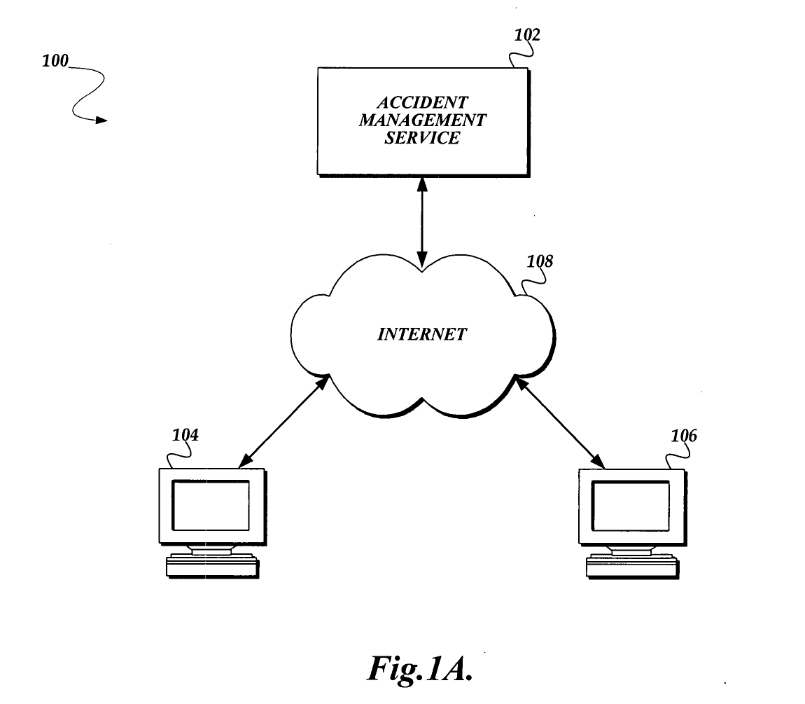

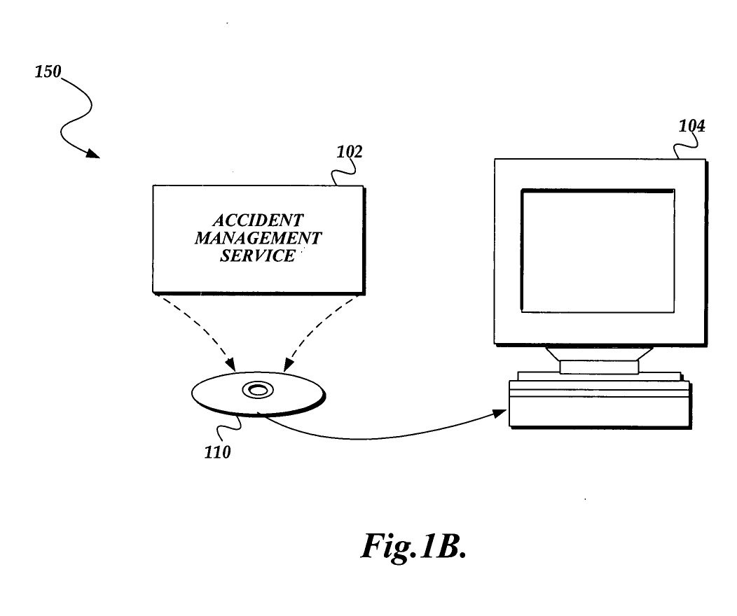

FIG. 1A is a pictorial diagram illustrating an exemplary environment, more particularly a networked environment 100, suitable for implementing aspects of the present invention. The exemplary networked environment 100 includes an accident management service 102 for organizing accident-related information, generating various accident-related ratings and evaluations, and generating settlement information and relevant forms for an accident person and/or system user.

An accident person accesses the accident management service 102 via the accident person's computer 104. In one embodiment, the accident person's computer 104 is connected to the accident management service 102, either logically or physically, over a network. For example, as illustrated in FIG. 1A, the accident person's computer 104 is connected to the accident management service 102 over the Internet 108. More particularly, according to one embodiment, the accident management service 102 is implemented as a Web service on a Web server connected to the Internet 108, and is accessed by the accident person via a Web browser located on the accident person's computer 104. Thus, the accident person submits, or posts, accident-related information using the Web browser on the accident person's computer 104. Submitting or posting information to the accident management service 102 may be accomplished in a single session, or alternatively, is accomplished through multiple or ongoing, sessions.

Also illustrated in the exemplary networked environment 100 is an attorney computer 106. Quite frequently, an accident person may turn to an attorney for assistance with regard to the issues surrounding an accident. The attorney, in turn, may advantageously access the accident management service 102 to assist in representing the accident person. The attorney accesses the accident management service 102 via the attorney computer 106. Alternatively, an accident person may utilize the accident management service 102 and subsequently “transfer” the accident information to the attorney. The accident person could transfer (or transmit) the accident information gathered and generated by the accident management service 102, permit the attorney to access the accident-related information stored at the accident management service 102, or provide the generated documents and accident forms to the attorney. Irrespective of how the attorney obtains the accident information, the attorney, via the attorney computer 106, may then use the accident information for various purposes, including, but not limited to: evaluate the “case” for possible representation; use and build on the accident information in the course of representation; submit the documents and forms generated by the accident management service 102 to file with other parties; and the like. In addition to using the accident information gathered and generated by the accident management service 102, as will be described in greater detail below, the attorney, via the attorney computer 106, will receive from the accident management service a case rating, as well as a case completion rating, regarding the accident information obtained from the accident person, for case evaluation purposes. Still further, for security purposes, an attorney or legal firm may host an accident management service internally and use it to evaluate cases or provide it as a service to clients.

FIG. 1A illustrates a networked environment 100 suitable for implementing aspects of the present invention. However, the network environment 100 should be viewed as illustrative only, and should not be construed as limiting upon the present invention. More particularly, the present invention may also be implemented in a stand-alone environment, i.e., where the accident management service 102 is remote to the accident person's computer 104. FIG. 1B is a pictorial diagram illustrating an alternative exemplary environment 150 suitable for implementing aspects of the present invention. In contrast to the exemplary networked environment 100 of FIG. 1A, the stand-alone system 150 of FIG. 1B includes only the accident person's computer 104.

Also illustrated in the exemplary stand-alone environment 150 is a computer-readable medium 110. As those skilled in the art will recognize, a computer-readable medium may be of any number of forms or formats, such as a CD-ROM or DVD disc, a floppy disk, a flash memory card device, magnetic tape, and the like. Thus, while the computer-readable medium 110 is illustrated as a CD-ROM or DVD disc, it should be viewed as illustrative only, and not construed as limited upon the present invention.

The computer-readable medium 110 includes computer-executable instructions, which when executed on the accident person's computer 104 carry out the same, or nearly the same, functionality and operations of the accident management service 102 in the exemplary networked environment 100. Thus, according to one embodiment of the present invention, the computer-readable medium 110 includes accident management service programs, data, tables, and the like. Though operating as a stand-alone accident management service, the accident person's computer 104 may be connected to a network, such as the Internet 108 (not shown). According to aspects of the present invention, a stand-alone accident management service environment 150 is able to transfer the accident information generated to an attorney (or rather the attorney computer 106) as described above in regard to FIG. 1A. In turn, the attorney may utilize a networked accident management service 102 such as illustrated in FIG. 1A, or have his own stand-alone accident management service environment 150.

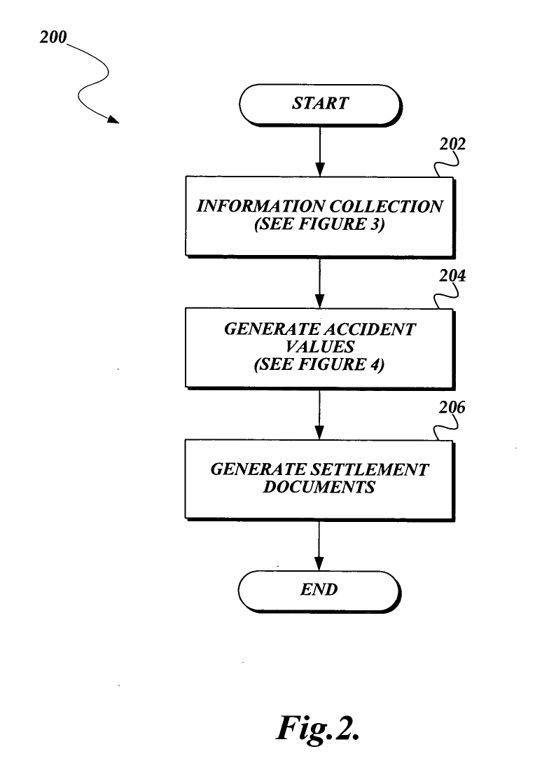

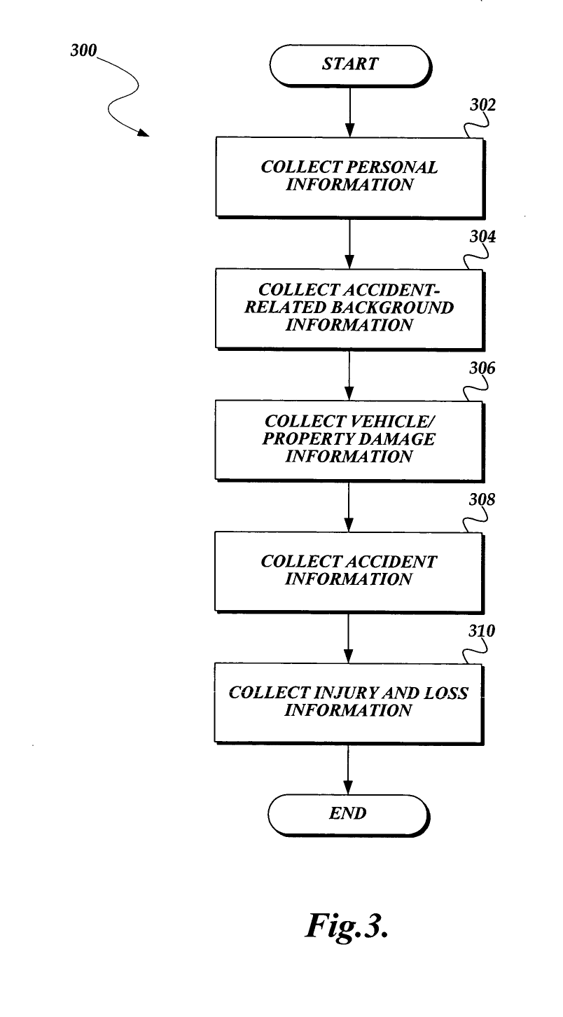

Whether the present invention is implemented as a Web service on a Web server, or alternatively, as a stand-alone system, the general operations of the accident management service 102 are similar. FIG. 2 is a flow diagram illustrating an exemplary routine 200 for providing accident management services to an accident person or other user, irrespective of its particular embodiment. Beginning at block 202, accident-related information is collected from the accident person (or another user entering the information). This accident information collection step is described in greater detail below in regard to FIG. 3.

FIG. 3 is a flow diagram illustrating an exemplary subroutine 300, suitable for use in the exemplary routine 200 of FIG. 2, for collecting accident-related information. Beginning at block 302, personal information regarding the accident person is collected. This personal information includes, but is not limited to, information such as the accident person's name, address, and insurance data including name of insurance company, policy number, type of coverage, limits of coverage, and medical insurance coverages.

At block 304, accident-related background information is collected. The accident-related background information includes, but is not limited to, information such as whether the accident person was in the vehicle at the time of the accident, whether the accident person was the driver of a vehicle involved in the accident, whether the accident person is the owner of a vehicle involved in the accident, whether a vehicle was damaged in the accident, whether there is more than one accident person, whether the accident person was working at the time of the accident, and whether the accident person was injured in the accident.

At block 306, vehicle and/or property damage information is collected. The vehicle damage information may include, but should not be limited to, information such as the maker of the vehicle involved in the accident as well as its model and year. The vehicle damage information also obtains information regarding the vehicle's lien holder and its estimated value. In one embodiment, the estimated value may be determined according to a “Blue Book” value, available online, locally available, or stored on the computer-readable medium 110. Additionally, the vehicle damage information includes whether the vehicle has been repaired or replaced, and information regarding the cost of repair or replacement is collected. According to aspects of the present invention, if the vehicle or property has not been repaired, the accident person (or other user) may be provided with information regarding obtaining repair or replacement estimates, as well as determining the value of the vehicle and the cost of purchasing another vehicle.

At block 308, information regarding the accident is also obtained. The accident information includes, but is not limited to, information such as where and when the accident occurred, the accident person's statement as to how the accident occurred, what damage, if any, was sustained by the vehicle, and what physically happened to the accident person during the accident. Additionally, the accident information includes whether the accident person was wearing a seatbelt, and if so, whether the seatbelt was a lap belt or included a shoulder harness. If the user is required to fill out an accident report in the jurisdiction where the accident occurred, the accident management service 102 will assist the accident person in completing the required accident report (if it is not already completed by local authorities). The accident person or other user will also be queried to provide detailed information regarding all witnesses to the accident, as well as witnesses who can testify how the injury has affected the accident person.

At block 310, information regarding personal injury and loss is collected, i.e., injuries to the accident person. The accident management service will help the accident person in documenting medical treatment received by the plaintiff by documenting each specific injury that resulted from the accident. In one embodiment, the accident management service will provide body part lists from which the accident person may identify particular injuries, though the system would not be limited to managing only injuries identified in the body part list. Once the body part is picked, the accident person will answer questions related to the particular injury to that body part. The services will support separate entries for each injury, such as to a knee, an arm, back or neck. Specific details relating to each injury, including the pain and suffering associated with each injury, may also be collected. Information relating to treatment of these injuries will also be collected, including, but not limited to, medical and/or chiropractic care, physical therapy, and prescription drugs, as well as injury related equipment such as crutches, wheelchair, prosthetics, etc. The accident management service 102 will keep a running total of all costs, including, but not limited to, medical, chiropractic, physical therapy, and prescription costs.

According to one embodiment, the accident management service 102 will also inquire as to whether any wage or income loss has occurred due to the accident, including, but not limited to, losses resulting from recovery time, time taken off due to therapy, inability to work, etc.

The accident management service 102 keeps an electronic diary or journal that permits the accident person to regularly document effects of the various injuries sustained in the accident. In one embodiment, the accident management service 102 enables the accident person to enter a rating from 1 to 10 to describe the severity of the injury and pain for the particular day (or, if opting for an hourly/per diem tracking, for that particular trackable period). The accident management service 102 will also prompt the accident person for information if the accident person fails to periodically provide that information.

After collecting the information, the exemplary routine 300 terminates. It should be appreciated that while the exemplary routine 300 identifies a particular order, it is illustrative only, and should not be construed as limiting upon the present invention. As such, the exemplary routine 300 should be viewed as illustrative only. Additionally, several of the steps identified in the exemplary routine 300 may be performed more than one time. For example, with regard to block 308, an accident person may repeatedly visit the accident management service 102 to enter additional information or update existing information.

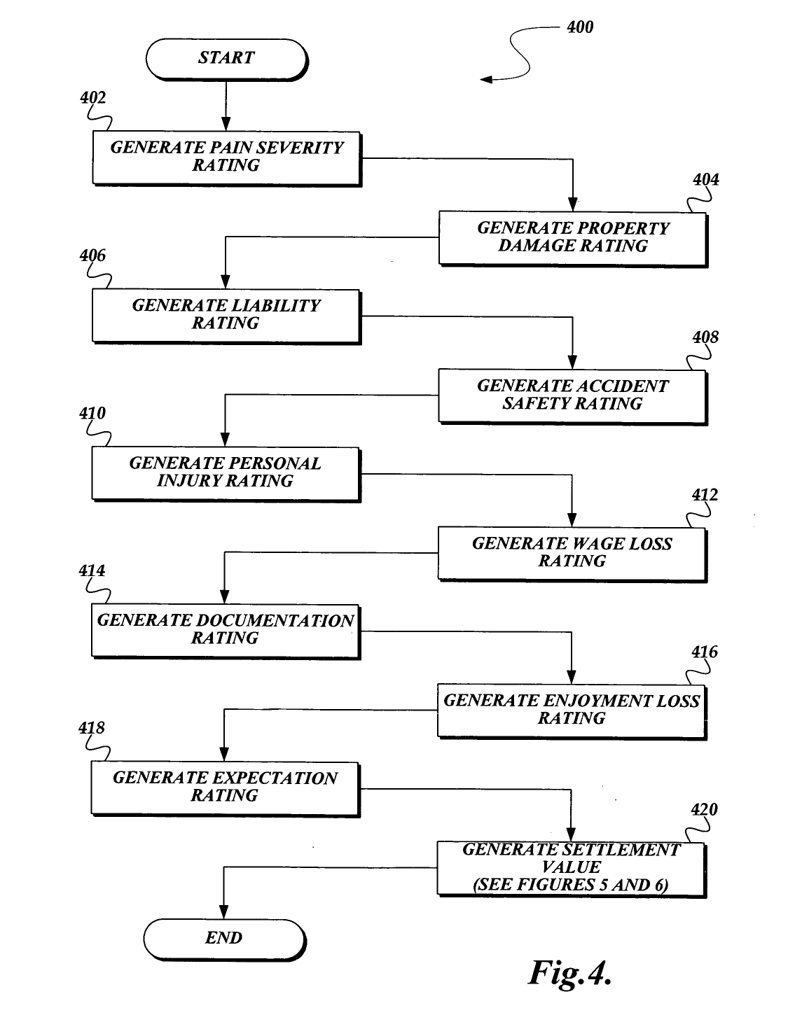

At some point after gathering accident-related information, the accident person will likely need to use the information, either for generating letters or other forms, making claims, civil litigation, settlement, and the like. In addition to providing the collected information in an organized format, the present invention also evaluates the collected information and generates corresponding accident values. FIG. 4 is a flow diagram illustrating an exemplary subroutine 400, suitable for use in the exemplary routine of FIG. 2, for generating accident values according to aspects of the present invention.

Beginning at block 402, a pain severity rating is generated. To generate the pain severity rating, the present invention analyzes the pain related information gathered with respect to the personal injury and loss information. According to one aspect of the present invention, this information is analyzed to determine the periods of times when the pain was more severe, and when it was less severe. Pain averages based on, but not limited to, type of pain, the period of pain, type of medical treatment, number of days in pain, number of hours in pain per day, and secondary effects of pain, are then evaluated by an algorithm to generate the pain severity rating, typically a number between 1 and 10.

At block 404, a property damage rating is generated. As with the pain severity rating (as well as all other ratings) the property damage rating will typically be a number between 1 and 10. The property damage rating is generated by an internal algorithm based on the cost of repair and value of the vehicle. At block 406, a liability rating is generated. To generate the liability rating, the present invention factors into consideration, but is not limited to, whether traffic citations were issued and to who, whether there were witnesses to corroborate the accident persons particular recitation of events, and the like. According to aspects of the present invention, a liability rating of 10would indicate that the accident person is completely fault free; a liability rating of 5 would indicate that the accident person is 50% at fault; and a liability rating of 1 would indicate that the accident person is completely at fault.

At block 408, an accident safety rating is generated. The accident safety rating is generated according to a number of factors including, but not limited to, whether a seatbelt was used, did the vehicle have its lights on, and the like. At block 410, a personal injury rating is generated. In contrast to the pain severity rating discussed above, the personal injury rating is generated as a function of the type and permanency of the injury (such as loss of limb and/or disfigurement), the total amount of the medical bills to date, the type of medical treatment received (such as physician, specialists, chiropractic, physical therapist, and masseuse treatments), the length of treatment, current prognosis, whether there were any delays in seeking treatment, and likely future treatment.

At block 412 a wage loss rating is generated. The wage loss rating is determined as a function of the lost wages that the accident person has entered into the system. At block 414 a documentation rating is generated. The documentation rating is generated according to factors such as whether the accident person has copies of all treatment records, the police report of the accident, wage-loss verification, witness statements, and the like.

At block 416 an enjoyment loss rating is generated. This enjoyment loss rating is generated as a function of the number of types of activities, hobbies, etc., that the accident person can no longer enjoy as a result of injuries suffered in the accident. At block 418 an expectation rating is generated. The expectation rating is determined as a function of the accident person's recovery expectations in regard to an average or median recovery for similar accidents and/or injuries.

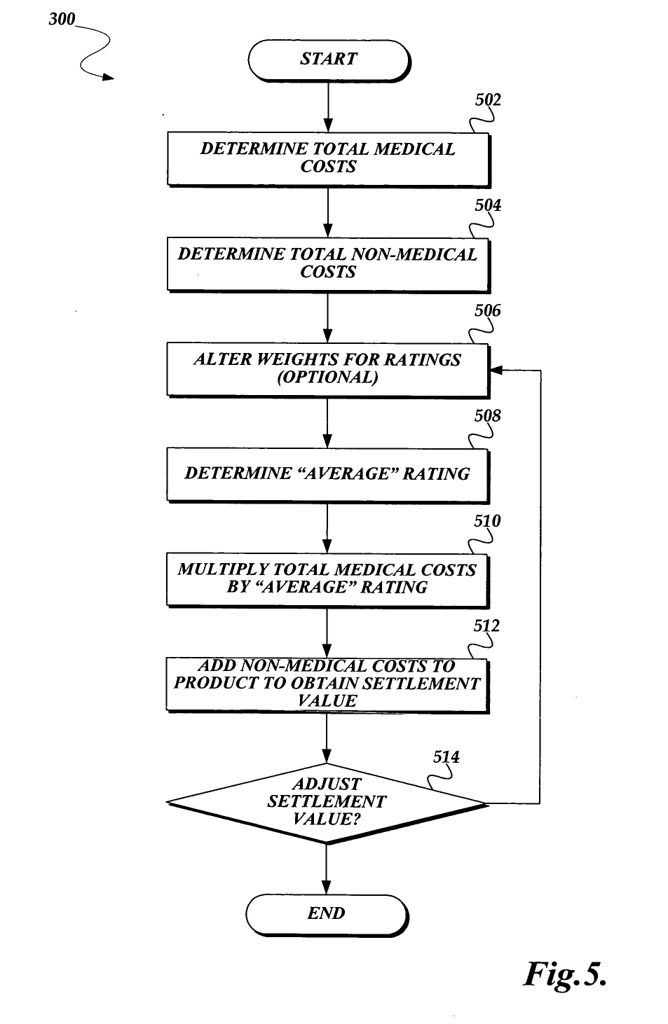

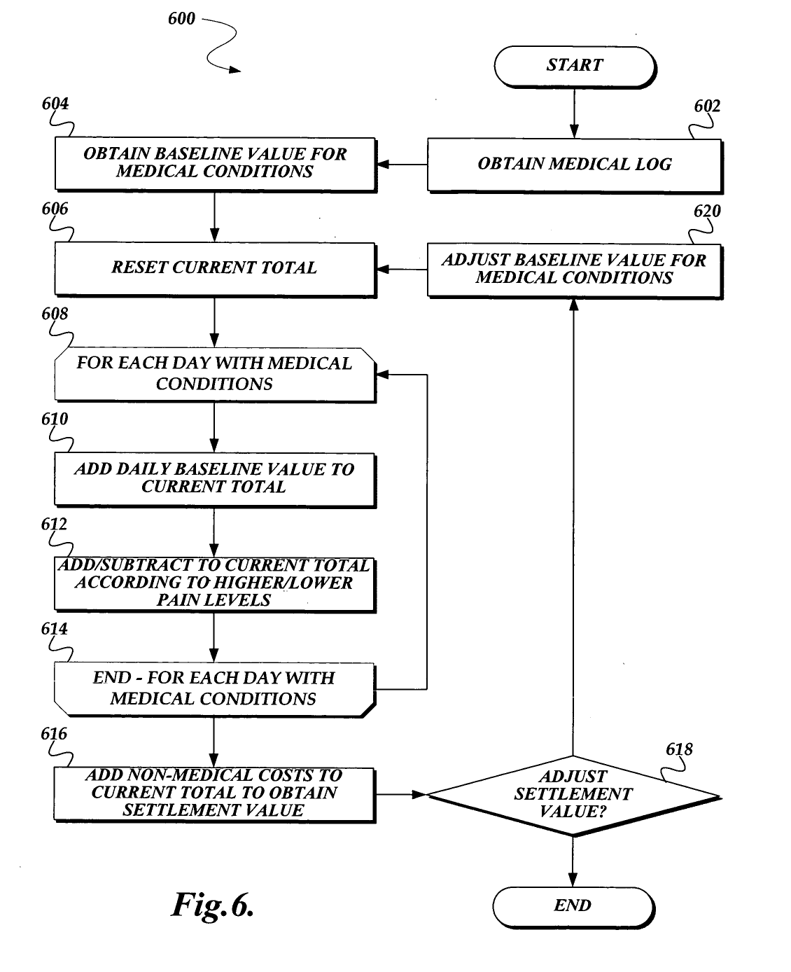

At block 420 a settlement value is generated. This settlement value corresponds to the value that the accident person is presenting to another party (e.g., an at-fault party, an insurance carrier, etc.) as the cost to settle the accident person's claims arising from the accident. A settlement value is generated as a function of the above determined ratings, as well as the costs and/or damages associated with the accident. While any number of algorithms may be used to determine a settlement cost, according to actual embodiments, there are at least two methodologies for determining a settlement value, described below in regard to FIG. 5 and FIG. 6. After generating the settlement value, the exemplary subroutine 400 terminates.

While the above described exemplary subroutine 400 describes a particular order for generating individual ratings, it should be understood that the order is illustrative only, and should not be construed as limiting upon the present invention.

FIG. 5 is a flow diagram illustrating an exemplary subroutine 500, suitable for use in the exemplary subroutine 400 of FIG. 4, for determining a settlement value for accident-related damages. Beginning at block 502, the total of all accident-related medical costs is determined. At block 504, the total for all accident-related non-medical damages is determined.

At block 506, the accident person, or other user, may optionally alter any of the weightings associated with the system-determined ratings to compensate for personal preference or other factors that may not have been accurately reflected within the information gathered by the system. In one embodiment, initially, all ratings are given the same weight (for averaging purposes as described below). However, according to aspects of the present invention, the accident person may alter the weight associated with each rating. As those skilled in the art will appreciate, altering the weightings of the various ratings has a direct effect when the average or median of the ratings is determined.

At block 508, an average rating is determined from all of the above ratings. As mentioned above, this average rating takes into account the weight associated with each individual rating. At block 510, the total medical costs are multiplied by the average rating. At block 512, the non-medical damages are added to the product of the multiplication, thereby yielding a settlement value.

In some situations, the accident person's settlement expectations do not coincide with the generated settlement value. Thus, at decision block 514, a determination is made as to whether the accident person wishes to adjust the settlement value. If so, the subroutine 500 returns to block 506 where the accident person can adjust the weights associated with particular ratings, which, as mentioned above, have a direct impact on the settlement value. However, if the accident person does not wish to alter the settlement value, the subroutine 500 terminates.

FIG. 6 is a flow diagram illustrating an alternative exemplary subroutine 600, suitable for use in the exemplary subroutine 400 of FIG. 4, for determining a settlement value for accident-related damages. In general, rather than multiplying the sum of medical costs by an average rating to produce a settlement value as described in regard to FIG. 5, this alternative subroutine 600 determines a settlement value according to the amount of time spent in pain with respect to the severity of pain.

As mentioned above, an accident person is able to log the type and severity of pain that the accident person experiences. Thus, beginning at block 602, the medical log kept by the system is obtained. At block 604, a baseline value for the medical conditions experienced by the accident person is obtained. According to aspects of the present invention, the baseline value may be a historic average value for injuries experienced by the accident person.

At block 606, a current total is set (or reset) to zero. At block 608, a for loop is initiated to examine the medical records of each day or hour. The purpose of this for loop is to evaluate each day's or hour's pain in relation to an average and add a corresponding amount to the current total. Thus, at block 610, the baseline value corresponding to the day or hour is added to the current total. At block 612, an adjustment is made to the current total according to the severity of the pain experienced during that period. For example, if the pain experienced during a particular day or hour is more severe than “average,” a commensurate amount is added to the current total. Similarly, if the pain experienced during a particular day or hour is less severe than “average,” a commensurate amount is subtracted from the current total. At block 614 the end of the for loop is reached and the subroutine 600 returns to block 608 if there are additional days or hours to process. However, if there are no remaining days to process, the subroutine 600 proceeds to block 616.

At block 616, non-medical damages are added to the current total to obtain a settlement value. However, as mentioned above in regard to subroutine 500, the accident person's settlement expectations may not coincide with the generated settlement value. Thus, at decision block 618, a determination is made as to whether the accident person wishes to adjust the settlement value. If so, the subroutine 600 proceeds to block 620, where the accident person can adjust baseline value. After adjusting the baseline value, at block 606, the current total is again reset and the for loop process is repeated. However, at decision block 618, if the accident person does not wish to alter the settlement value, the subroutine 600 terminates.

Returning again to FIG. 2, after having generated the accident values, including the ratings and settlement value, the system then generates settlement documents, including forms, letters, and the like. These settlement documents are designed to beneficially organize the information collected by the accident management service 102 such that when presented to another party, the information is clearly and rationally presented to the other party in full support of the accident person's claims and settlement value. These settlement documents include, but are not limited to, insurance forms, vehicle information, accident forms, witness information, non-medical expenses, medical providers and billings, daily logs, checklists, accident management service ratings, settlement values, and the like. In addition to printing settlement documents, the accident management service 102 may also offer download-able forms for items such as demand letters for property, insurance, and personal injury claims, consultation request letters for attorneys, requests for police reports, appraiser checklists, and the like. These settlement documents would be automatically filled in based on the information entered by the accident person. Thereafter, the exemplary routine 200 terminates.

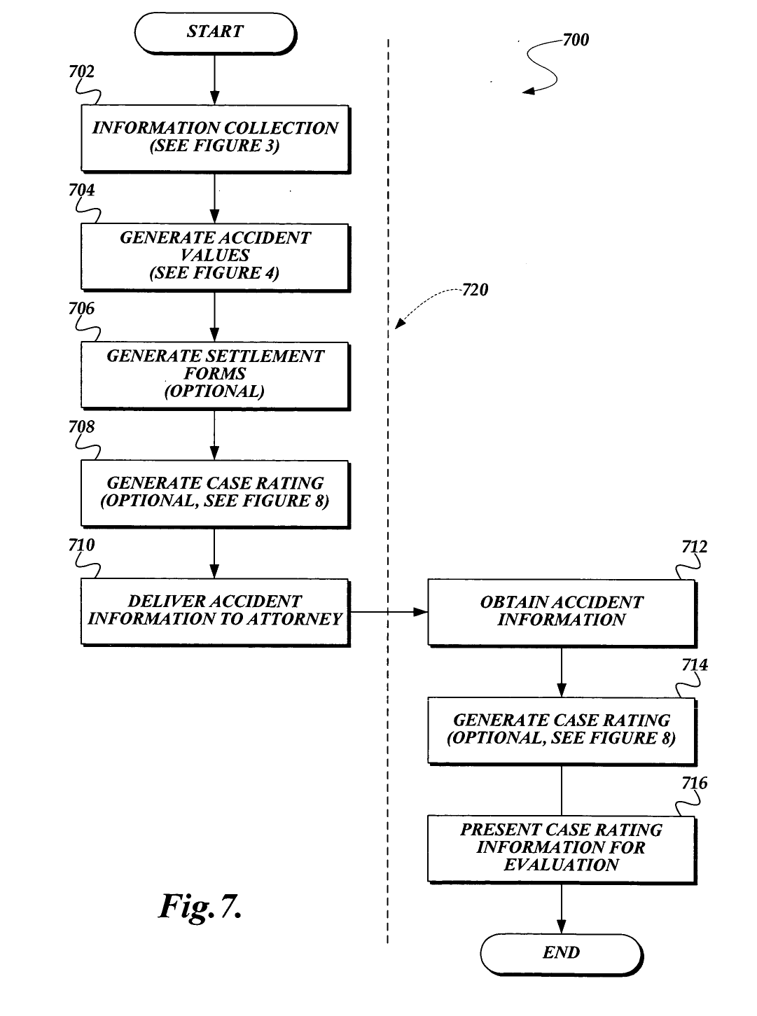

In addition to assisting the accident person in individually pursuing settlement issues with another party, the present invention may be advantageously used to assist an attorney in evaluating where to represent the accident person in the accident person's claims against another party. FIG. 7 is a flow diagram illustrating an exemplary routine for providing accident management service 102 to an accident person and assisting an attorney in evaluating the accident case presented by the accident person for representation. FIG. 7 is divided into two sections separated by line 720. Items appearing on the left of line 720 represent actions taken by the accident person. Similarly, items appearing on the right of line 720 represent actions taken by the attorney.

Beginning at block 702, the accident person begins the process by collecting the accident-related information. Collecting the accident-related information has been described above in regard to FIG. 3. At block 704, the accident management service 102 generates the accident values, as described above in regard to FIG. 4. Optionally, at block 706, the accident person directs the accident management service 102 to generate the settlement documents. One download-able document that may of particular use would be a consultation request form, though it is not required.

At block 708, the accident management service 102 may optionally generate a case rating so that the attorney can better evaluate the case. At block 710, the information collected and generated by the accident management service 102 is provided to the attorney. This information may include the printed forms, a copy of the electronic information stored by the accident management service 102, or simply a reference and authorization to access the information at the accident management service.

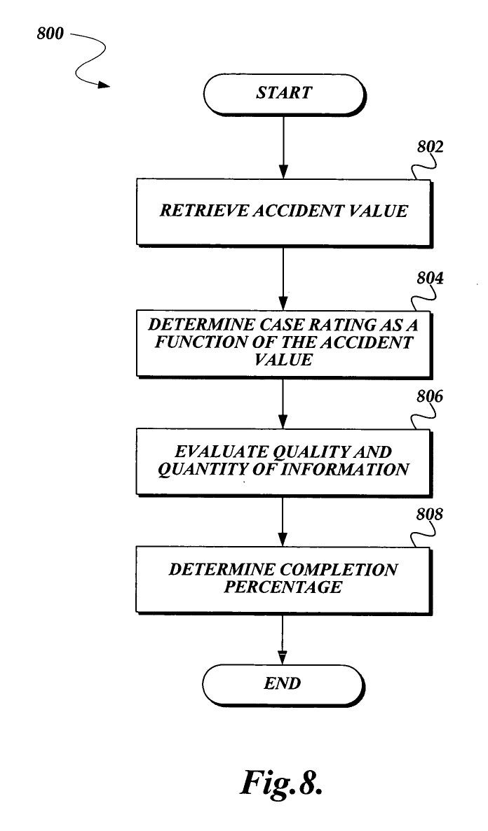

At block 712, the attorney obtains the accident information from the accident person. At block 714, the attorney optionally generates a case rating for the accident (if it was not done so by the accident person). Alternatively, the attorney may, as a matter of due course, have a case rating generated for the accident. Generating a case rating is described in greater detail below in regard to FIG. 8.

FIG. 8 is a flow diagram illustrating an exemplary subroutine 800, suitable for use in the exemplary routine 700 of FIG. 7, for determining an accident case rating and completion percentage for evaluating the case for possible representation.

Beginning at block 802, the settlement value determined by the accident management service 102 is retrieved. At block 804, the settlement value is used to determine the case rating. As with previous ratings discussed, a case rating is typically a number between 1 and 10. However, as will be discussed below, additional qualifiers may be added. In one embodiment, if a settlement value falls under $10,000, the accident person's case is assigned a case rating of 1. Cases valued between $10,000 up to, but not including, $20,000 are assigned a case rating of 2; cases valued between $20,000 up to, but not including, $30,000 are assigned a case rating of 3. This continues until cases valued at or above $100,000 are assigned a case rating of 10. Larger case values are assigned a “+” for each additional $100,000. Thus, a settlement value of $300,000 would receive a case rating of “10++.”

In addition to a case rating, the accident management service 102 provides the attorney with an evaluation as to the amount of work that may be required to bring the potential case to completion. Thus, at block 806, the quality and quantity of information provided by the accident person is evaluated to determine what remains to be done on the case. At block 808, according to previously determined heuristics, such as a historic record of the amount of time each case requires, this evaluation is used to determine a completion percentage, which, in conjunction with the case rating, assist the attorney to objectively evaluation an accident case for possible representation. Thereafter, the exemplary subroutine 800 terminates.

Returning again to FIG. 7, after having generated the case rating and completion percentage, the information is presented to the attorney for evaluation. Thereafter, the exemplary routine 700 terminates.

According to additional aspects of the present invention, the accident management service 102 may provide various on-line services for users such as accident persons. For example, in one embodiment, the accident management service 102 provides an attorney referral service for those seeking help with an accident. Additionally, the referral service could allow the users to provide feedback concerning the services they received from the referred attorney. The users could rate the attorney according to the service based on criteria/factors presented by the accident management service 102.

While various embodiment of the present invention, including the preferred embodiment, have been illustrated and described, it will be appreciated that various changes can be made therein without departing from the spirit and scope of the invention.

1. A computer-implemented method for generating settlement information for an accident person in regard to an accident, the method comprising:
at a computer:
collecting accident-related information for the accident person;
determining a settlement function by which a settlement value may be derived from the collected accident-related information; and
applying the settlement function to the accident-related information, thereby generating a settlement value for the accident person.

2. The computer-implemented method of claim 1 further comprising generating settlement documents based on the collected accident-related information in support of the settlement value.

3. The computer-implemented method of claim 1, wherein the accident-related information comprises medical costs, and wherein determining the settlement function by which the settlement value may be derived from the collected accident-related information comprises:
determining a settlement rating; and
multiplying the medical costs by the settlement rating.

4. The computer-implemented method of claim 3, wherein the accident-related information further comprises non-medical damages, and wherein determining the settlement function by which the settlement value may be derived from the collected accident-related information further comprises adding the non-medical damages to the product of multiplying the medical costs by the settlement rating.

5. The computer-implemented method of claim 4, wherein determining a settlement rating comprises:
determining a plurality of accident-related ratings according to the accident-related information; and
averaging the plurality of accident-related ratings as the settlement rating.

6. The computer-implemented method of claim 5, wherein averaging the plurality of accident-related ratings as the settlement rating comprises:
obtaining a weighting associated with one of the plurality of accident-related ratings; and
averaging the plurality of accident-related ratings according to the weightings of each of the plurality of accident-related ratings.

7. The computer-implemented method of claim 5, wherein the accident-related information comprises further comprises pain severity information, and wherein the plurality of accident-related ratings comprises pain severity rating determined according to the pain severity information.

8. The computer-implemented method of claim 5, wherein the accident-related information comprises further comprises accident liability information, and wherein the plurality of accident-related ratings comprises a liability rating determined according to the accident liability information.

9. The computer-implemented method of claim 5, wherein the accident-related information comprises further comprises property damage information, and wherein the plurality of accident-related ratings comprises a property damage rating determined according to the property damage information.

10. The computer-implemented method of claim 5, wherein the accident-related information comprises further comprises accident safety information, and wherein the plurality of accident-related ratings comprises an accident safety rating determined according to the accident safety information.

11. The computer-implemented method of claim 5, wherein the accident-related information comprises further comprises personal injury information relating to the type of personal injuries sustained by the accident person, and wherein the plurality of accident-related ratings comprises a personal injury rating determined according to the personal injury information.

12. The computer-implemented method of claim 5, wherein the accident-related information comprises further comprises wage loss information, and wherein the plurality of accident-related ratings comprises a wage loss rating determined according to the wage loss information.

13. The computer-implemented method of claim 5, wherein the plurality of accident-related ratings comprises a documentation rating determined according to the accident-related documentation in the accident-related information.

14. The computer-implemented method of claim 5, wherein the accident-related information comprises further comprises enjoyment loss information, and wherein the plurality of accident-related ratings comprises an enjoyment loss rating determined according to the enjoyment loss information.

15. The computer-implemented method of claim 5, wherein the plurality of accident-related ratings comprises an expectation rating determined according to the accident person's settlement expectations.

16. A computer-implemented method for generating settlement information for an accident person in regard to an accident, the method comprising:
at a computer:
collecting accident-related information for the accident person;
obtaining a baseline value for accident-related medical conditions identified in the accident-related information; and
for each day of the medical conditions:
adding the baseline value to a current total; and
adjusting the current total according to whether the pain level for the medical conditions for that day was higher or lower than an average pain level; and
adding non-medical damages to the current total thereby generating the settlement value.

17. The computer-implemented method of claim 16, wherein the baseline value is adjustable by a user.

18. A computer-readable medium bearing computer-executable instructions which, when executed on a computing device, carry out a method for generating settlement information for an accident person in regard to an accident, the method comprising:
collecting accident-related information for the accident person, wherein the accident-related information comprises medical and non-medical damages;
determining a settlement rating derived from the collected accident-related information, wherein the settlement rating is determined by:
determining a plurality of accident-related ratings according to aspects of the accident-related information; and
averaging the plurality of accident-related ratings, thereby determining the settlement rating;
multiplying the medical costs by the settlement rating; and
adding non-medical damages to the product of the medical costs multiplied by the settlement rating.

19. A computer-readable medium bearing computer-executable instructions which, when executed on a computing device, carry out a method for generating settlement information for an accident person in regard to an accident, the method comprising:
collecting accident-related information for the accident person, wherein the accident-related information comprises medical and non-medical damages;
obtaining a baseline value for accident-related medical conditions identified in the accident-related information; and
for each day of the medical conditions:
adding the baseline value to a current total; and
adjusting the current total according to whether the pain level for the medical conditions for that day was higher or lower than an average pain level; and
adding non-medical damages to the current total thereby generating a settlement value.

20. A network-based system for generating settlement information for an accident person in regard to an accident, the system comprising:
an accident person computer for submitting accident-related information to an accident management service for generating settlement information and receiving settlement information from the accident management service; and
an accident management service, communicatively coupled to the user computer via a network connection, wherein the accident management service:
collects accident-related information for the accident person from the accident person computer, wherein the accident-related information comprises medical and non-medical damages;
determines a settlement rating derived from the collected accident-related information, wherein the settlement rating is determined by:
generating a plurality of accident-related ratings according to aspects of the accident-related information; and
averaging the plurality of accident-related ratings, thereby generating the settlement rating;
multiplies the medical costs by the settlement rating;
adds non-medical damages to the product of the medical costs multiplied by the settlement rating, thereby generating a settlement value; and
returns the settlement value to the accident person computer.

21. A network-based system for generating settlement information for an accident person in regard to an accident, the system comprising:
an accident person computer for submitting accident-related information to an accident management service for generating settlement information and receiving settlement information from the accident management service; and
an accident management service, communicatively coupled to the user computer via a network connection, wherein the accident management service:
collects accident-related information for the accident person from the accident person computer, wherein the accident-related information comprises medical and non-medical damages;
obtains a baseline value for accident-related medical conditions identified in the accident-related information; and
for each day of the medical conditions identified in the accident-related information:
adds the baseline value to a current total; and
adjusts the current total according to whether the pain level associated with the medical conditions for that day was higher or lower than an average pain level; and
adds non-medical damages to the current total thereby generating a settlement value.
